(19) United States
(12) Patent Application Publication
(10) Pub. No.: US 2025/0292466 A1
(43) Pub. Date: Sep. 18, 2025

(54) METHOD FOR GENERATING VIDEO HAVING BORDER IMAGE AND DEVICE

(71) Applicant: Beijing Zitiao Network Technology Co., Ltd., Beijing (CN)

(72) Inventors: Saisai WANG, Beijing (CN); Quan MENG, Beijing (CN); Kun OUYANG, Beijing (CN); Ziyan HAN, Beijing (CN)

(21) Appl. No.: 19/078,036

(22) Filed: Mar. 12, 2025

(30) Foreign Application Priority Data
Mar. 12, 2024 (CN) 202410282374.0

(51) Int. Cl. G06T 11/60; G06F 40/284; G06F 40/40; G06T 7/00; G06V 10/82; G06V 20/40; G06V 20/62

(52) U.S. Cl. CPC G06T 11/60; G06F 40/284; G06F 40/40; G06T 7/0002; G06V 20/46; G06V 20/62; G06T 2207/10016; G06T 2207/20084; G06T 2207/30168; G06V 10/82

(57) ABSTRACT

The present disclosure provides a method for generating a video having a border image and a device. The method includes: acquiring a first video; extracting, from the first video, a text for describing content in the first video; generating a border image based on the text, where the text is used to determine content of the border image; and compositing the first video with the border image to obtain a second video.

### CROSS-REFERENCE TO RELATED APPLICATION

The present application claims priority of the Chinese Patent Application No. 202410282374.0, filed on Mar. 12, 2024, the disclosure of which is incorporated herein by reference in its entirety as part of the present application.

### TECHNICAL FIELD

Embodiments of the present disclosure relate to the technical field of computer vision, and in particular, to a method for generating a video having a border image and a device.

### BACKGROUND

In the field of computer vision, content is displayed through images, videos, and the like. For example, advertisement content may be displayed through videos. Displaying content through videos provides a more intuitive user experience and is therefore widely used in various scenarios.

For example, a video may be further processed. For example, a text, an image, audio, and the like may be added to the video to allow the processed video to have richer content. The text may be input through a keyboard, and the images and the audio may be selected by a user from a preset library, where both the images and the text may include words.

However, the above solution suffers from the problem of poor effects of the generated videos.

### SUMMARY

The embodiment of the present disclosure provides a method for generating a video having a border image. The method includes: acquiring a first video; extracting, from the first video, a text for describing content in the first video; generating a border image based on the text, where the text is used to determine content of the border image; and compositing the first video with the border image to obtain a second video.

The embodiment of the present disclosure provides an apparatus for generating a video having a border image. The apparatus includes: a first-video acquisition module, a text extraction module, a border image generation module and a second-video generation module. The first-video acquisition module is configured to acquire a first video. The text extraction module is configured to extract, from the first video, a text for describing content in the first video. The border image generation module is configured to generate a border image based on the text, where the text is used to determine content of the border image. The second-video generation module configured to composite the first video with the border image to obtain a second video.

The embodiment of the present disclosure provides an electronic device. The electronic device includes: at least one processor and a memory. The memory stores computer-executable instructions; and the at least one processor executes the computer-executable instructions stored in the memory, to cause the electronic device to implement the method mentioned above.

The embodiment of the present disclosure provides a computer-readable storage medium. The computer-readable storage medium stores computer-executable instructions, and when the computer-executable instructions are executed by a processor, a computing device is caused to implement the method mentioned above.

The embodiment of the present disclosure provides a computer program that is used for implementing the method mentioned above.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is a schematic diagram of a relationship between a first video, a border image, and a second video according to the present disclosure;

FIG. 2 is a schematic diagram of a video generation process according to the present disclosure;

FIG. 3 is a flowchart of steps of a method for generating a video having a border image according to an embodiment of the present disclosure;

FIG. 4 is a schematic diagram of a video generation process according to an embodiment of the present disclosure;

FIG. 5 is a flowchart of steps of another method for generating a video having a border image according to an embodiment of the present disclosure;

FIG. 6 is a block diagram of a structure of an apparatus for generating a video having a border image according to an embodiment of the present disclosure; and

FIG. 7 is a block diagram of a structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All the other embodiments obtained by those of ordinary skill in the art based on the embodiments of the present disclosure without any creative effort shall fall within the scope of protection of the present disclosure.

The present disclosure is used to add a border image to a first video to form a new second video. The border image is located around the periphery of the first video, such that the content of each video frame of the second video includes the border image and a video frame of the first video located inside the border image. The border image may be understood as a border of the first video, similar to a photo frame.

It can be understood that the first video is any video without a border image added, and the second video is a video obtained after adding the border image to the first video. The first video may be any video, for example, a user generated content (UGC) video.

FIG. 1 is a schematic diagram of a relationship between a first video, a border image, and a second video according to the present disclosure. As shown in FIG. 1, a video frame of the first video is located inside the border image, and the video frame of the first video and the border image form a video frame of the second video together.

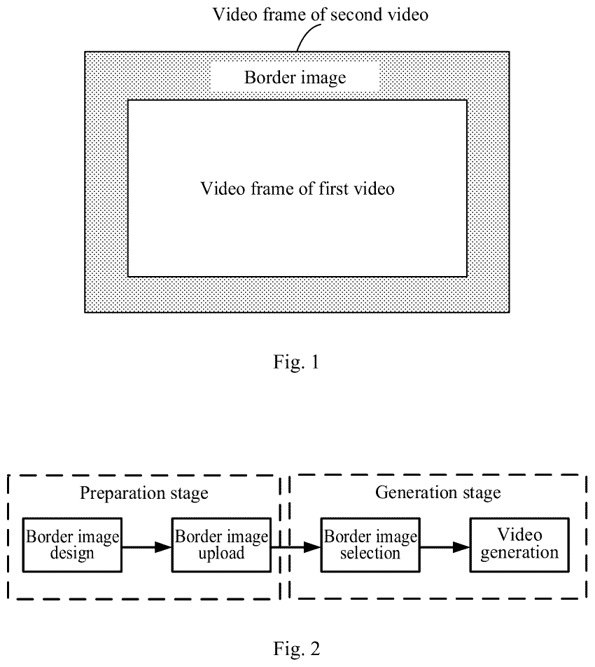

In some solutions, a user may select a border image from a border image library, so as to add the border image to the periphery of the first video to form the second video. FIG. 2 is a schematic diagram of a video generation process according to the present disclosure. As shown in FIG. 2, the above video generation process includes two stages: a preparation stage and a generation stage. The preparation stage includes two sub-stages: a border image design sub-stage and a border image upload sub-stage. The generation stage includes two sub-stages: a border image selection sub-stage and a video generation sub-stage.

In the above border image design sub-stage, a designer can use Adobe After Effects (AE), which is a graphics and video processing software, to design a border image.

In the above border image upload sub-stage, the designer uploads the designed border image to the border image library for storage.

In the above border image selection sub-stage, the user logs in to a client to select a border image that is required to be used from the above border image library, and selects a first video on the client.

In the above video generation sub-stage, the user performs an operation on the client to confirm the use of the border image and the first video, in order to generate a second video based on the border image and the first video.

However, the border image in the above solution has the problems of lack of diversity and personalization, resulting in poor effects of the generated videos.

In order to solve the above technical problem, according to the present disclosure, a text for the content in the first video is extracted from the first video, so as to generate a border image based on the text. In this way, the generated border image is an image associated with the content of the first video. It helps to improve the richness and personalization of the border image and can effectively improve the generation effect of the video.

The technical solutions in the embodiments of the present disclosure and how the technical solutions of the present disclosure solve the above technical problem are described below in detail with specific embodiments. The following several specific embodiments may be combined with each other, and details about same or similar concepts or processes may not be described in some embodiments again. The embodiments of the present disclosure are described below with reference to the accompanying drawings.

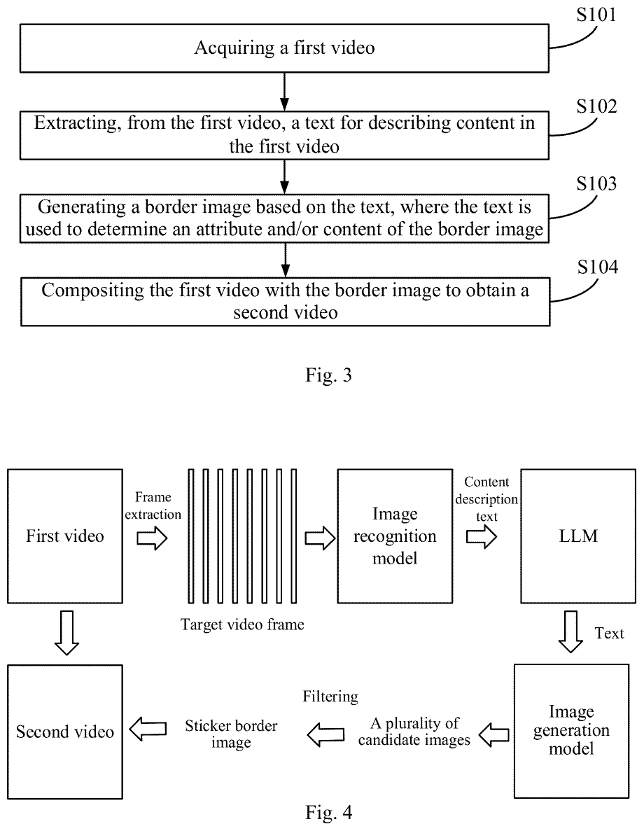

FIG. 3 is a flowchart of steps of a method for generating a video having a border image according to an embodiment of the present disclosure. As shown in FIG. 3, the method for generating a video having a border image includes the following steps.

S101: acquiring a first video.

The first video may be any video acquired in any manner.

S102: extracting, from the first video, a text for describing content in the first video.

The text here is any text used to represent the content in the first video, and may be obtained by performing image recognition on any video frame of the first video. The text for describing the content in the first video may be a semantically continuous natural language text, or a keyword text that includes a plurality of keywords. It can be understood that when the text for describing the content in the first video includes keywords, the redundancy of information input into an image generation model when generating a border image may be reduced, thereby reducing the complexity of generating the border image.

Specifically, all or some of the video frames of the first video may be respectively input into an image recognition model to obtain a description text corresponding to each of the video frames, so as to generate, based on description texts respectively corresponding to the video frames, the above text for describing the content in the first video. Specifically, the description texts of the video frames may be aggregated, and duplicate content in the description texts may be deleted to obtain the text for describing the content in the first video.

It can be understood that the above image recognition model may be any neural network model obtained through pre-training. For example, a commonly used image recognition model may be a contrastive language image pre training (CLIP) model, which is a pre-trained neural network model for matching images and texts, which is an open-source large model.

S103: generating a border image based on the text, where the text is used to determine an attribute and/or content of the border image.

The border image is any image that is used to be added to the periphery of the first video and is associated with the text for describing the content in the first video. The attribute of the border image includes at least one selected from the group consisting: a target location in the border image for adding a video, color, a size, a style, and a shape. Different texts for describing the content in the first video may correspond to border images with different attributes and/or content. It can be seen that the above text for describing the content in the first video is used to determine the target location of the first video in the border image, the color of the border image, the size of the border image, the style of the border image, the shape of the border image, and the content of the border image.

The target location in the border image for adding the video may be a part of the area inside the border image, for example, may be a central sub-area inside the border image, so as to add the video frames of the first video to the central sub-area of the border image. In this embodiment of the present disclosure, the target location is not fixed, but is associated with the content in the first video, and content in different first videos corresponds to different target locations. In this way, for the first videos with different content, the position of the generated second video may be different, which can improve the personalization of the second video.

The above border image may be generated by the following process: inputting the text for describing the content in the first video into an image generation model to obtain the border image. The image generation model may be any neural network model that has an image generation function.

Certainly, the above image generation model may also be generated through pre-training, and a second training set required to be used during the pre-training process may include a large number of sample texts and a sample image corresponding to each sample text. These sample texts are associated with the attributes and/or content of the sample images. Thus, the association relationship between the sample texts and the sample images may be identified through the pre-training process, so that when the image generation model is applied, the image generation model may generate, based on the text for describing the content in the first video, a border image associated with the text.

In some implementations, for some or all of the video frames in the first video, the respectively corresponding texts for describing the content in the first video are extracted. Taking one of the video frames as an example, a border image corresponding to a video frame may be generated based on a text for describing the content in the first video, where the text corresponds to this video frame that is used. In this way, for each video frame of the some or all of the video frames, a border image can be obtained, so that different video frames in the first video correspond to different border images, thereby further improving the richness of the border images and the effect of the generated videos.

S104: compositing the first video with the border image to obtain a second video.

It can be understood that the process of generating the second video includes adding the first video to the target location in the border image to obtain the second video. The specific implementation is as follows: adding each video frame of the first video to the target location in the corresponding border image to obtain each video frame of the second video.

The target location may be any location inside the border image, and typically, the target location may be a central location of the border image.

In summary, in this embodiment of the present disclosure, a border image associated with the content of the first video can be generated to form a second video. In this way, the first video and the border image in the second video may be associated, thus ensuring the matching between the two, which in turn improves the generation effect of the second video.

In some implementations, the above S102, when extracting the text for describing the content in the first video, may specifically include: firstly, extracting a content description text from the first video; then, splitting the content description text based on a subject and a scene to obtain a subject description text and a scene description text; and finally, generating, based on the subject description text and the scene description text, the text for describing the content in the first video.

The content description text is used to describe the content in the first video and may be obtained through recognition by an image recognition model. The content description text output by the image recognition model is a continuous natural language text, which can be directly used as the text for describing the content in the first video. However, in order to more accurately describe the content of the first video and improve the description accuracy of the text for describing the content in the first video, the content description text may be processed and then used as the text for describing the content in the first video.

It can be seen from the above description that the text for describing the content in the first video includes a subject description text and a scene description text, where the subject description text is used to describe a subject in the first video, and the scene description text is used to describe a scene in the first video. Thus, when generating a border image based on the text for describing the content in the first video, the border image may be generated separately based on the subject and the scene, allowing for flexible adjustment of the degree of influence of the subject and the scene on the border image. For example, the weight of the subject description text may be set higher and the weight of the scene description text may be set lower, so that the generated border image matches the subject more closely. Certainly, the weights here can be flexibly set according to actual needs.

In order to further reduce the redundancy of the text for describing the content in the first video, tokenization may be performed on the subject description text and the scene description text to obtain a plurality of tokens, so as to determine, based on the plurality of tokens, the text for describing the content in the first video. Thus, the text for describing the content in the first video includes keywords from two dimensions: keywords for describing the subject and keywords for describing the scene. In this way, not only can the content of the first video be described from two dimensions, but also the redundancy of the text for describing the content in the first video can be reduced as much as possible, thereby reducing the complexity of generating images by image generation model based on the text. In addition, the interference of redundant information can be avoided, which helps to improve the accuracy of the generated images.

In some implementations, before the determining, based on the plurality of tokens, the text for describing the content in the first video, a first degree of importance of tokens corresponding to the subject description text in the subject description text may be determined, and a second degree of importance of tokens corresponding to the scene description text in the scene description text may be determined. Then, target tokens are deleted from the plurality of tokens.

The target tokens include: one or more tokens of which the first degree of importance is the smallest, and one or more tokens of which the second degree of importance is the smallest. The first degree of importance is used to indicate the degree of importance of tokens in the subject description text to the subject, and the second degree of importance is used to indicate the degree of importance of tokens in the scene description text to the scene. In this way, some unimportant tokens may be deleted to further reduce the redundancy of the target tokens.

The following example illustrates the relationship between the content description text, the subject description text, the scene description text, and the text for describing the content in the first video. For example, the content description text may be “A parrot is walking on the balcony, with the blue sky and trees in the background”, the split subject description text may be “parrot, walking”, and the scene description text may be “balcony, blue sky, trees”. After tokenization is performed on the subject description text, two tokens “parrot” and “walking” are obtained, and after tokenization is performed on the scene description text, three tokens “balcony”, “blue sky”, and “trees” are obtained. The text for describing the content in the first video, which is obtained after some of the tokens are deleted, may include “parrot” and “balcony”.

In some implementations, in order to further improve the processing complexity and the accuracy of the content description text, the content description text may be extracted from some video frames of the first video. Specifically, firstly, second quality information respectively corresponding to video frames in the first video is determined, and the second quality information includes at least one selected from the group consisting: content richness, video frame resolution, a degree of exposure, and a color contrast; then, a target video frame is selected from the video frames based on the second quality information; and finally, the content description text is extracted from the target video frame.

The target video frame is one or more video frames of the highest quality in the first video. For the process of extracting the content description text from the target video frame, reference may be made to the aforementioned process of extracting the content description text from any video frame.

The above content richness may be represented by the number of objects and the number of object types included in the video frame. A larger number of objects and/or a larger number of object types indicates a higher content richness, and thus a higher quality of the video frame. For example, in response to no clear object in a video frame, the content richness of the video frame is low. For another example, for a video frame B1 with four types of objects: a human face, an animal, a grassland, blue sky and trees, and a video frame B2 with one type of object: a human face, the number of object types in the video frame B1 is 4, and the number of object types in the video frame B2 is 1. Therefore, the content richness of the video frame B1 is higher than that of the video frame B2. It can be understood that the content description text extracted from a video frame with higher content richness may include richer content, so that more diverse border images may be generated. This helps to further improve the correlation between the border image and the first video, as well as the video effect.

For the above video frame resolution, the higher the value of the video frame resolution, the higher the quality of the video frame. For a video frame with high video resolution, the recognized text for describing the content in the first video is more accurate, which can improve the correlation between the border image and the first video, as well as the video effect.

For the above degree of exposure, when the value of the degree of exposure is within a reasonable range, the quality of the video frame is higher. For a video frame with a reasonable degree of exposure, the recognized text for describing the content in the first video is more accurate, which can improve the correlation between the border image and the first video, as well as the video effect.

For the above color contrast, the higher the value of the color contrast, the higher the quality of the video frame. For a video frame with a high color contrast, the recognized text for describing the content in the first video is more accurate, which can improve the correlation between the border image and the first video, as well as the video effect.

It can be seen that in this embodiment of the present disclosure, the target video frame can be selected based on quality information in a plurality of dimensions to extract the text for describing the content in the first video. The accuracy and richness of the text for describing the content in the first video can be improved as much as possible, which helps to improve the video effect.

In practical application, a key frame may also be used as the target video frame, which can avoid quality analysis of the first video and reduce the complexity and time consumption of extracting the text for describing the content in the first video. In addition, the quality of the key frame is generally high, which can ensure the accuracy of the text for describing the content in the first video.

It can be understood that a series of processing used in the above process of generating, based on the content description text, the text for describing the content in the first video may be implemented through a natural language processing model. For example, a commonly used natural language processing model may be a large language model (LLM).

After acquiring the text for describing the content in the first video through the above process, the S103 may further be performed to generate a border image. It can be seen from the aforementioned description of the S103 that the text for describing the content in the first video may be input into the image generation model, so that the image output by the image generation model is used as the border image. In some implementations, the above S203, when generating the border image, may include: firstly, inputting the text for describing the content in the first video into an image generation model to obtain at least two candidate images; then, determining a degree of correlation between each of the candidate images and a vertical category of video content; and finally, selecting the border image from the candidate images based on the degree of correlation. In this way, the image generation model can be controlled to generate a plurality of candidate images, from which a border image related to a vertical category of the first video is selected, so that the matching between the border image and the first video can be improved, thereby improving the quality of the second video.

The vertical category is the vertical category of the first video, which is used to indicate the type of the content in the first video. For example, the vertical category of the first video may be a food video, an interview video, a live streaming video, and the like.

In this embodiment of the present disclosure, the candidate images and the vertical category of the first video may be input into a correlation model, and the degree of correlation between the candidate images and the first video on the vertical category may be obtained. The correlation model can be any neural network model, for example, a chatGPT model.

On the basis of filtering a border image based on the vertical category above, the border image may further be selected in conjunction with quality. Specifically, firstly, first quality information of each of the candidate images is acquired; and then, the border image is selected from the candidate images based on the first quality information and the degree of correlation.

The border image may be an image with a high quality and a high degree of correlation among the plurality of candidate images. Before selecting the border image, the first quality information is numerically processed to obtain a quality parameter, so that the border image is selected based on the quality parameter and the degree of correlation.

In the first example of selecting the border image, a candidate image of which the quality parameter is greater than or equal to a preset quality threshold and of which the degree of correlation is greater than or equal to a preset degree of correlation threshold is selected as the border image, or the candidate images are comprehensively ranked in accordance with quality parameters and degrees of correlation to select a most highly ranked candidate image as the border image.

In the second example of selecting the border image, a comprehensive quality parameter of each candidate image is determined based on the quality parameter and the degree of correlation, so as to use a candidate image of which the comprehensive quality parameter is greater than or equal to a preset comprehensive quality threshold as the border image, or a candidate image with the largest comprehensive quality parameter as the border image.

It can be seen that this embodiment of the present disclosure can improve the quality of the border image as much as possible while ensuring the association with the vertical category of the first video, which helps to improve the quality of the second video.

It can be understood that the above first quality information can describe the quality of candidate images from at least one dimension. Therefore, the first quality information includes at least one selected from the group consisting of: resolution, exposure, noise, color, a composition, a degree of subject emphasis, whether a subject being missing, and whether a scene being missing.

When the resolution is higher, the exposure is within a reasonable range, the noise is smaller, the color is brighter, the composition is better, the degree of subject emphasis is higher, the subject is not missing and the scene is not missing, the quality of the candidate image is higher.

The higher the resolution, the smaller the area where blurring, out-of-focus, jaggedness, mosaics, etc., exist in the candidate image.

FIG. 4 is a schematic diagram of a video generation process according to an embodiment of the present disclosure. After the user selects the first video, the process shown in FIG. 4 may be executed.

As shown in FIG. 4, after the user selects the first video, frame extraction is first performed on the first video to obtain a target video frame. The target video frame here may be a video frame with a high quality in the first video. For example, the target video may be a key frame.

After acquiring the target video frame through frame extraction, the target video frame may be input into the image recognition model to extract a content description text from the target video frame.

After acquiring the content description text, the content description text may be processed through the LLM model to obtain the text for describing the content in the first video. The processing here may include a plurality of processes: splitting the content description text to obtain a subject description text and a scene description text, performing tokenization on the subject description text and the scene description text, and determining the first degrees of importance of tokens of the subject description text and the second degrees of importance of tokens of the scene description text. The plurality of processes may respectively correspond to an LLM model, that is, there may be more than one LLM model here.

After obtaining the text for describing the content in the first video, the text for describing the content in the first video is input into the image generation model to obtain a plurality of candidate images.

After obtaining the plurality of candidate images, a border image may be filtered from the plurality of candidate images.

After obtaining the border image, the first video and the border image may be composited to obtain a second video. The second video is a video obtained by compositing the first video with the border image.

In summary, the present disclosure can build an artificial intelligence generated content (AIGC) platform to intelligently generate personalized and form-rich border images for the first video, which can improve the generation effect of the video. This can also avoid the step of the user selecting the border image, reduce the complexity of user operations, and reduce the step of the designer designing the border image, thereby reducing the labor cost and realizing the mass production of the border image.

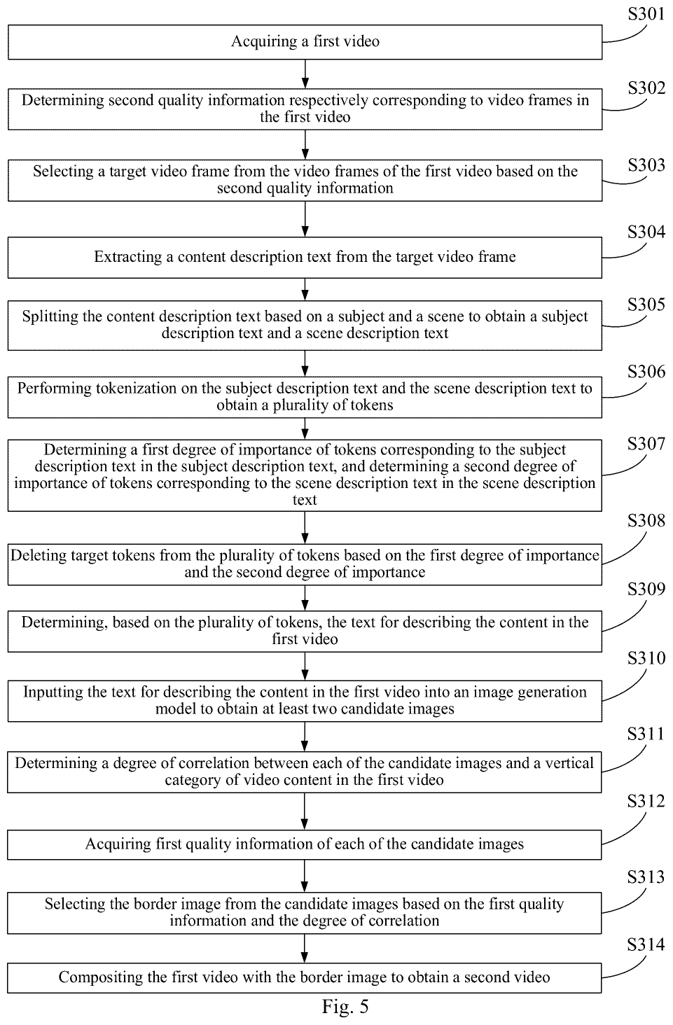

FIG. 5 is a flowchart of steps of another method for generating a video having a border image according to an embodiment of the present disclosure. As shown in FIG. 5, the above method for generating a video having a border image may include the following steps.

S301: acquiring a first video.

S302: determining second quality information respectively corresponding to video frames in the first video.

The second quality information includes at least one selected from the group consisting: content richness, video frame resolution, degree of exposure, and color contrast.

S303: selecting a target video frame from the video frames of the first video based on the second quality information.

S304: extracting a content description text from the target video frame.

S305: splitting the content description text based on a subject and a scene to obtain a subject description text and a scene description text.

S306: performing tokenization on the subject description text and the scene description text to obtain a plurality of tokens.

S307: determining a first degree of importance of tokens corresponding to the subject description text in the subject description text, and determining a second degree of importance of tokens corresponding to the scene description text in the scene description text.

S308: deleting target tokens from the plurality of tokens based on the first degree of importance and the second degree of importance.

The target tokens include: one or more tokens of which the first degree of importance is the smallest, and one or more tokens of which the second degree of importance is the smallest.

S309: determining, based on the plurality of tokens, the text for describing the content in the first video.

S310: inputting the text for describing the content in the first video into an image generation model to obtain at least two candidate images.

S311: determining a degree of correlation between each of the candidate images and a vertical category of video content in the first video.

S312: acquiring first quality information of each of the candidate images.

S313: selecting the border image from the candidate images based on the first quality information and the degree of correlation.

S314: compositing the first video with the border image to obtain a second video.

It should be noted that the order of the steps shown in FIG. 5 can be flexibly adjusted on a mutually independent basis. In addition, for the above method for generating a video having a border image, reference can be made to the corresponding description of the method for generating a video having a border image shown in FIG. 3, which will not be repeated herein.

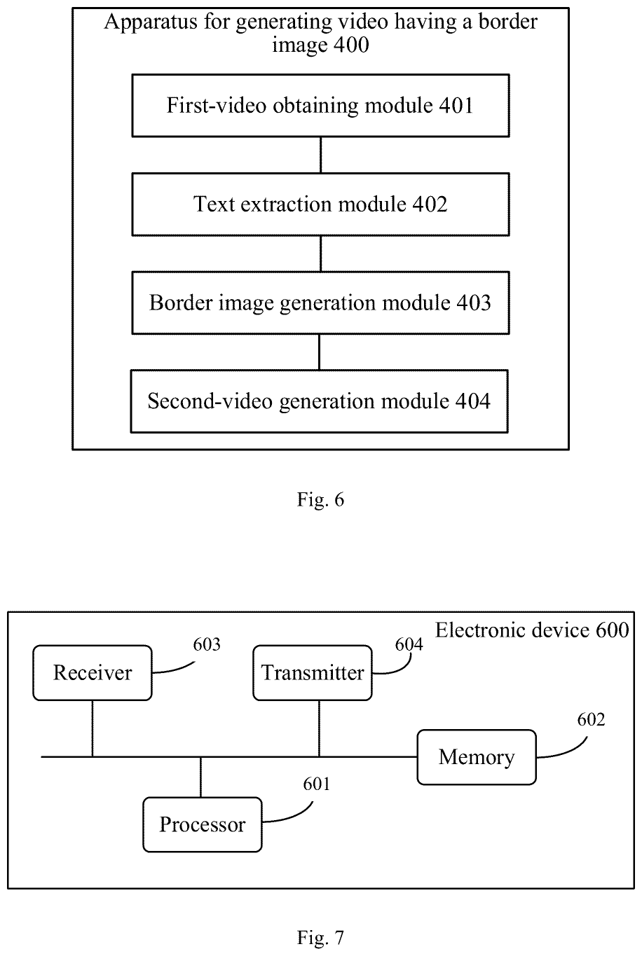

Corresponding to the method for generating a video having a border image in the above embodiments, FIG. 6 is a block diagram of a structure of an apparatus for generating a video having a border image according to an embodiment of the present disclosure. For ease of illustration, only parts related to this embodiment of the present disclosure are shown. As shown in FIG. 6, the apparatus 400 for generating a video having a border image includes: a first-video acquisition module 401, a text extraction module 402, a border image generation module 403 and a second-video generation module 404.

The first-video acquisition module 401 is configured to acquire a first video.

The text extraction module 402 configured to extract, from the first video, a text for describing content in the first video.

The border image generation module 403 is configured to generate a border image based on the text. The text is used to determine an attribute and/or content of the border image.

The second-video generation module 404 is configured to composite the first video with the border image to obtain a second video.

Optionally, the border image generation module 403 is further configured to: input the text for describing the content in the first video into an image generation model to obtain at least two candidate images; determine a degree of correlation between each of the candidate images and a vertical category of the first video; and select the border image from the candidate images based on the degree of correlation.

Optionally, the border image generation module 403 is further configured to: acquire first quality information of each of the candidate images; and select the border image from the candidate images based on the first quality information and the degree of correlation.

Optionally, the first quality information includes at least one selected from the group consisting of: resolution, exposure, noise, color, a composition, a degree of subject emphasis, whether a subject being missing, and whether a scene being missing.

Optionally, the text extraction module 402 is further configured to: extract a content description text from the first video; split the content description text based on a subject and a scene to obtain a subject description text and a scene description text; and generate the text for describing the content in the first video based on the subject description text and the scene description text.

Optionally, the text extraction module 402 is further configured to: perform tokenization on the subject description text and the scene description text to obtain a plurality of tokens; and determine, based on the plurality of tokens, the text for describing the content in the first video.

Optionally, the apparatus further includes a degree of importance determination module and a token deleting module.

The degree of importance determination module is configured to, before the determining, based on the plurality of tokens, the text for describing the content in the first video, determine a first degree of importance of tokens corresponding to the subject description text in the subject description text, and determine a second degree of importance of tokens corresponding to the scene description text in the scene description text.

The token deleting module is configured to delete target tokens from the plurality of tokens, the target tokens including: one or more tokens of which the first degree of importance is the smallest, and one or more tokens of which the second degree of importance is the smallest.

Optionally, the text extraction module 402 is further configured to: determine second quality information respectively corresponding to video frames in the first video, where the second quality information includes at least one selected from the group consisting: content richness, video frame resolution, a degree of exposure, and a color contrast; select a target video frame from the video frames based on the second quality information; and extract the content description text from the target video frame.

Optionally, the attribute of the border image includes at least one selected from the group consisting: a target location in the border image for adding a video, color, a size, a style, and a shape.

The apparatus for generating a video having a border image according to this embodiment may be configured to perform the technical solution of the above embodiment of the method for generating a video having a border image. The implementation principles and technical effects thereof are similar, which are not repeated in this embodiment.

FIG. 7 is a block diagram of a structure of an electronic device according to an embodiment of the present disclosure. The electronic device 600 includes a memory 602 and at least one processor 601.

The memory 602 stores computer-executable instructions.

The at least one processor 601 executes the computer-executable instructions stored in the memory 602, to cause the electronic device 600 to implement the above method for generating a video having a border image.

In addition, the electronic device may further include a receiver 603 and a transmitter 604. The receiver 603 is configured to receive information from other apparatuses or devices and forward the information to the processor 601. The transmitter 604 is configured to transmit information to other apparatuses or devices.

An embodiment of the present disclosure provides a method for generating a video having a border image. The method includes: acquiring a first video; extracting, from the first video, a text for describing content in the first video; generating a border image based on the text, where the text is used to determine an attribute and/or content of the border image; and compositing the first video with the border image to obtain a second video.

For example, the generating a border image based on the text includes: inputting the text into an image generation model to obtain at least two candidate images; determining a degree of correlation between each of the candidate images and a vertical category of the first video; and selecting the border image from the candidate images based on the degree of correlation.

For example, the selecting the border image from the candidate images based on the degree of correlation, includes: acquiring first quality information of each of the candidate images; and selecting the border image from the candidate images based on the first quality information and the degree of correlation.

For example, the first quality information includes at least one selected from the group consisting of: resolution, exposure, noise, color, a composition, a degree of subject emphasis, whether a subject being missing, and whether a scene being missing.

For example, the extracting, from the first video, a text for describing content in the first video, includes: extracting a content description text from the first video; splitting the content description text based on a subject and a scene to obtain a subject description text and a scene description text; and generating the text for describing the content in the first video based on the subject description text and the scene description text.

For example, the generating the text based on the subject description text and the scene description text, includes: performing tokenization on the subject description text and the scene description text to obtain a plurality of tokens; and determining, based on the plurality of tokens, the text for describing the content in the first video.

For example, before the determining, based on the plurality of tokens, the text for describing the content in the first video, the method further includes: determining a first degree of importance of tokens corresponding to the subject description text in the subject description text, and determining a second degree of importance of tokens corresponding to the scene description text in the scene description text; and deleting target tokens from the plurality of tokens, where the target tokens include: one or more tokens of which the first degree of importance is the smallest, and one or more tokens of which the second degree of importance is the smallest.

For example, the extracting a content description text from the first video includes: determining second quality information respectively corresponding to video frames in the first video, where the second quality information includes at least one selected from the group consisting: content richness, video frame resolution, a degree of exposure, and a color contrast; selecting a target video frame from the video frames based on the second quality information; and extracting the content description text from the target video frame.

For example, the attribute of the border image includes at least one selected from the group consisting: a target location in the border image for adding a video, color, a size, a style, and a shape.

An embodiment of the present disclosure provides an apparatus for generating a video having a border image is provided. The apparatus includes: a first-video acquisition module, a text extraction module, a border image generation module and a second-video generation module.

The first-video acquisition module is configured to acquire a first video.

The text extraction module is configured to extract, from the first video, a text for describing content in the first video.

The border image generation module is configured to generate a border image based on the text, where the text is used to determine an attribute and/or content of the border image.

The second-video generation module configured to composite the first video with the border image to obtain a second video.

For example, the border image generation module is further configured to: input the text into an image generation model to obtain at least two candidate images; determine a degree of correlation between each of the candidate images and a vertical category of the first video; and select the border image from the candidate images based on the degree of correlation.

For example, the border image generation module is further configured to: acquire first quality information of each of the candidate images; and select the border image from the candidate images based on the first quality information and the degree of correlation.

For example, the first quality information includes at least one selected from the group consisting of: resolution, exposure, noise, color, a composition, a degree of subject emphasis, whether a subject being missing, and whether a scene being missing.

For example, the text extraction module is further configured to: extract a content description text from the first video; split the content description text based on a subject and a scene to obtain a subject description text and a scene description text; and generate the text for describing the content in the first video based on the subject description text and the scene description text.

For example, the text extraction module is further configured to: perform tokenization on the subject description text and the scene description text to obtain a plurality of tokens; and determine, based on the plurality of tokens, the text for describing the content in the first video.

For example, the apparatus further includes: a degree of importance determination module and a token deleting module.

The degree of importance determination module is configured to, before the determining, based on the plurality of tokens, the text for describing the content in the first video, determine a first degree of importance of tokens corresponding to the subject description text in the subject description text, and determine a second degree of importance of tokens corresponding to the scene description text in the scene description text.

The token deleting module is configured to delete target tokens from the plurality of tokens, where the target tokens include: one or more tokens of which the first degree of importance is the smallest, and one or more tokens of which the second degree of importance is the smallest.

For example, the text extraction module is further configured to: determine second quality information respectively corresponding to video frames in the first video, where the second quality information includes at least one selected from the group consisting: content richness, video frame resolution, a degree of exposure, and a color contrast; select a target video frame from the video frames based on the second quality information; and extract the content description text from the target video frame.

For example, the attribute of the border image includes at least one selected from the group consisting: a target location in the border image for adding a video, color, a size, a style, and a shape.

According to one or more embodiments of the present disclosure, an electronic device is provided. The electronic device includes: at least one processor and a memory.

The memory stores computer-executable instructions.

The at least one processor executes the computer-executable instructions stored in the memory, to cause the electronic device to implement the method for generating a video having a border image of any one of the above embodiments.

One or more embodiments of the present disclosure provide a computer-readable storage medium. The computer-readable storage medium stores computer-executable instructions, and when the computer-executable instructions are executed by a processor, a computing device is caused to implement the method for generating a video having a border image of any one of the above embodiments.

One or more embodiments of the present disclosure provide a computer program used for implementing the method for generating a video having a border image of any one of the above embodiments.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method for generating a video having a border image, comprising:
acquiring a first video;
extracting, from the first video, a text for describing content in the first video;
generating the border image based on the text, wherein the text is used to determine content of the border image; and
compositing the first video with the border image to obtain a second video.

2. The method according to claim 1, wherein the generating of the border image based on the text, comprises:
inputting the text into an image generation model to obtain at least two candidate images;
determining a degree of correlation between each of the candidate images and a vertical category of the first video; and
selecting the border image from the candidate images based on the degree of correlation.

3. The method according to claim 2, wherein the selecting the border image from the candidate images based on the degree of correlation, comprises:
acquiring first quality information of each of the candidate images; and
selecting the border image from the candidate images based on the first quality information and the degree of correlation.

4. The method according to claim 3, wherein the first quality information comprises at least one selected from the group consisting of: resolution, exposure, noise, color, a composition, a degree of subject emphasis, whether a subject being missing, and whether a scene being missing.

5. The method according to claim 1, wherein the extracting, from the first video, the text for describing the content in the first video, comprises:
extracting a content description text from the first video;
splitting the content description text based on a subject and a scene to obtain a subject description text and a scene description text; and
generating, based on the subject description text and the scene description text, the text for describing the content in the first video.

6. The method according to claim 5, wherein the generating, based on the subject description text and the scene description text, the text for describing the content in the first video, comprises:
performing tokenization on the subject description text and the scene description text to obtain a plurality of tokens; and
determining, based on the plurality of tokens, the text for describing the content in the first video.

7. The method according to claim 6, wherein before the determining, based on the plurality of tokens, the text for describing the content in the first video, the method further comprises:
determining a first degree of importance of tokens corresponding to the subject description text in the subject description text, and determining a second degree of importance of tokens corresponding to the scene description text in the scene description text; and
deleting target tokens from the plurality of tokens, wherein the target tokens comprise: one or more tokens of which the first degree of importance is smallest, and one or more tokens of which the second degree of importance is smallest.

8. The method according to claim 6, wherein the extracting of the content description text from the first video, comprises:
determining second quality information respectively corresponding to video frames in the first video, wherein the second quality information comprises at least one selected from the group consisting: content richness, video frame resolution, a degree of exposure, and a color contrast;
selecting a target video frame from the video frames based on the second quality information; and
extracting the content description text from the target video frame.

9. The method according to claim 1, wherein the text is used to determine an attribute of the border image, and the attribute of the border image comprises at least one selected from the group consisting: a target location in the border image for adding a video, color, a size, a style, and a shape.

10. An electronic device, comprising: at least one processor and a memory,
wherein the memory stores computer-executable instructions; and
the at least one processor executes the computer-executable instructions stored in the memory, to cause the electronic device to implement a method for generating a video having a border image, and the method comprises:
acquiring a first video;
extracting, from the first video, a text for describing content in the first video;
generating the border image based on the text, wherein the text is used to determine content of the border image; and
compositing the first video with the border image to obtain a second video.

11. A non-transitory computer-readable storage medium, wherein the non-transitory computer-readable storage medium stores computer-executable instructions, when the computer-executable instructions are executed by a processor, a computing device is caused to implement a method for generating a video having a border image, and the method comprises:
acquiring a first video;
extracting, from the first video, a text for describing content in the first video;
generating the border image based on the text, wherein the text is used to determine content of the border image; and
compositing the first video with the border image to obtain a second video.

12. The electronic device according to claim 10, wherein the generating of the border image based on the text, comprises:
inputting the text into an image generation model to obtain at least two candidate images;
determining a degree of correlation between each of the candidate images and a vertical category of the first video; and
selecting the border image from the candidate images based on the degree of correlation.

13. The electronic device according to claim 12, wherein the selecting the border image from the candidate images based on the degree of correlation, comprises:
acquiring first quality information of each of the candidate images; and
selecting the border image from the candidate images based on the first quality information and the degree of correlation.

14. The electronic device according to claim 13, wherein the first quality information comprises at least one selected from the group consisting of: resolution, exposure, noise, color, a composition, a degree of subject emphasis, whether a subject being missing, and whether a scene being missing.

15. The electronic device according to claim 10, wherein the extracting, from the first video, the text for describing the content in the first video, comprises:
extracting a content description text from the first video;
splitting the content description text based on a subject and a scene to obtain a subject description text and a scene description text; and
generating, based on the subject description text and the scene description text, the text for describing the content in the first video.

16. The electronic device according to claim 15, wherein the generating, based on the subject description text and the scene description text, the text for describing the content in the first video, comprises:
performing tokenization on the subject description text and the scene description text to obtain a plurality of tokens; and
determining, based on the plurality of tokens, the text for describing the content in the first video.

17. The electronic device according to claim 16, wherein before the determining, based on the plurality of tokens, the text for describing the content in the first video, the method further comprises:
determining a first degree of importance of tokens corresponding to the subject description text in the subject description text, and determining a second degree of importance of tokens corresponding to the scene description text in the scene description text; and
deleting target tokens from the plurality of tokens, wherein the target tokens comprise: one or more tokens of which the first degree of importance is smallest, and one or more tokens of which the second degree of importance is smallest.

18. The electronic device according to claim 16, wherein the extracting of the content description text from the first video, comprises:
determining second quality information respectively corresponding to video frames in the first video, wherein the second quality information comprises at least one selected from the group consisting: content richness, video frame resolution, a degree of exposure, and a color contrast;
selecting a target video frame from the video frames based on the second quality information; and
extracting the content description text from the target video frame.

19. The electronic device according to claim 10, wherein the text is used to determine an attribute of the border image, and the attribute of the border image comprises at least one selected from the group consisting: a target location in the border image for adding a video, color, a size, a style, and a shape.

20. The non-transitory computer-readable storage medium according to claim 11, wherein the generating of the border image based on the text, comprises:
inputting the text into an image generation model to obtain at least two candidate images;
determining a degree of correlation between each of the candidate images and a vertical category of the first video; and
selecting the border image from the candidate images based on the degree of correlation.
